(19) United States
(12) Patent Application Publication
(10) Pub. No.: US 2026/0149651 A1
(43) Pub. Date: May 28, 2026

(54) NETWORK MONITORING DEVICES AND METHODS

(71) Applicant: EQUINIX INC., Redwood City, CA (US)

(72) Inventor: Reshad Rahman, Ottawa (CA)

(73) Assignee: EQUINIX INC., Redwood City, CA (US)

(21) Appl. No.: 18/962,675

(22) Filed: Nov. 27, 2024

(51) Int. Cl. H04L 43/0811; H04L 43/10

(52) U.S. Cl. CPC H04L 43/0811; H04L 43/10

(57) ABSTRACT

A node of a network includes a network interface configured to receive incoming bidirectional forward detection (BFD) echo packets from an originating node and to transmit return BFD echo packets with performance metrics appended thereto back to the originating node. The node also includes a performance metrics generator configured to collect the performance metrics related to at least the node and a processor configured to append the performance metrics to the outgoing BFD echo packets. Other apparatus and methods are disclosed herein.

### FIELD OF THE DISCLOSURE

The present disclosure relates generally to networks for data communications. In particular, but not by way of limitation, the present disclosure relates to systems, methods, and apparatuses for providing real time network status.

### BACKGROUND

Communications networks route data between points in the networks by way of many different communications paths. The networks include nodes that are in communication with each other to create the communications paths. When a communication link between two or more nodes forming a communications path becomes faulty, devices in the network can reroute data to another communications path to bypass the faulty communication link.

The process or determining that a communication link is faulty can be time consuming relative to data speeds required for applications such as machine learning and artificial intelligence. In addition, transmitting network status of all the nodes and communication links in the network can cause latency on the network. Therefore, a need exists for devices and methods that can quickly determine network status without causing latency.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some embodiments of the disclosure may be characterized as a node of a network, wherein the node includes a network interface configured to receive outgoing bidirectional forward detection (BFD) echo packets from at least a first node and to transmit return BFD echo packets with performance metrics appended thereto back to at least the first node; a performance metrics generator configured to collect the performance metrics related to at least the node; and a processor configured to append the performance metrics to the outgoing BFD echo packets.

Other embodiments of the disclosure may be characterized as node of a network, wherein the node includes a network interface configured to receive return bidirectional forward detection (BFD) echo packets with performance metrics appended thereto from at least a first node of the network; and a processor coupled to the network interface, wherein the processor is configured to extract the performance metrics from the return BFD echo packets.

Other embodiments of the disclosure may be characterized as a method of operating a network, wherein the method includes providing a network having at least a first node and a second node; acquiring first performance metrics pertaining to at least one metric of the network; storing the first performance metrics in the second node; transmitting an outgoing BFD echo packet from the first node to the second node; receiving the outgoing BFD echo packet in the second node; appending the first performance metrics to a return BFD echo packet; and transmitting the return BFD echo packet with the first performance metrics appended thereto to the first node.

Other embodiments of the disclosure may be characterized as a network for transmitting data, wherein the network includes a first node; and a second node, wherein: the first node is configured to: transmit outgoing BFD echo packets to the second node; receive return BFD echo packets from the first node; and extract first performance metrics from the return BFD echo packets, and the second node is configured to: receive the outgoing BFD echo packets from the first node; append the first performance metrics to the return BFD echo packets to the first node; transmit the return BFD echo packets back to the first node.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates a schematic block diagram of a network according to one or more embodiments;

FIG. 2 illustrates a schematic diagram of an intermediate node in the network of FIG. 1, wherein the node is configured to transmit and receive BFD echo packets according to one or more embodiments;

FIG. 3 is a flowchart describing a method of operating the node of FIG. 2 according to one or more embodiments;

FIGS. 4A-4C illustrate an example of a round robin or daisy chain data transmission that may be applied to the network of FIG. 1 according to one or more embodiments;

FIG. 5 illustrates a block diagram of a node, such as an upstream end node that does not include a performance metrics generator, according to one or more embodiments;

FIG. 6 illustrates a block diagram of a node, such as a downstream end node that does not include a BFD echo packet generator, according to one or more embodiments;

FIG. 7 illustrates a schematic block diagram of a network having more nodes than the network of FIG. 1 according to one or more embodiments; and

FIG. 8 is a flowchart describing a method of operating a network according to one or more embodiments.

### DETAILED DESCRIPTION

Preliminary note: the flowcharts and block diagrams in the following figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a circuit, module, or system. Furthermore, aspects of the present disclosure may take the form of a computer program product embodied in one or more computer readable medium(s) having computer readable program code embodied thereon.

Networks transfer data via communications paths between points of the networks. The communications paths are formed between a plurality of nodes (e.g., routers, bridges, and switches). The nodes may include devices that transmit data to nodes, receive data from nodes, generate data (e.g., data packets), process data, and/or route data between different nodes and/or endpoints. In order to optimize data transfers between the nodes, certain data routing devices in the network may determine the optimal communications paths based on certain performance metrics of the network. The performance metrics may include latency, jitter, packet loss, queue depths, node temperature, energy consumption and other metrics. Thus, the devices that select the optimal communications paths may select data communications paths with minimal latency, packet loss, and jitter, and that use nodes with low queue depths. Over time, such as within a second, the performance metrics of a selected communications path may become unfavorable. Once this unfavorable condition occurs, data needs to be transferred via an alternate communications path quickly in order to avoid communications errors.

This quick change in communications paths necessitates that the performance metrics of the nodes and/or the communications paths be continuously monitored. Conventional devices and methods used to monitor networks do not provide fast or real time monitoring. Some conventional devices and methods transfer large quantities of data pertaining to performance metrics that increase data traffic, especially as the networks increase in size and complexity. Additionally, these conventional devices and methods may not be able to monitor the networks with the high reliability and speed requirements of artificial intelligence (AI) and machine learning (ML) applications.

The devices and methods described herein overcome issues with conventional devices and methods by appending performance metrics to return bidirectional forwarding detection (BFD) echo packets to quickly transfer performance metrics throughout the networks. Network status may then be continuously updated in substantially real time. Data routing devices in the network may then select optimal communications paths in real time to accommodate applications such as AI and ML that require continuous high speed data transfers. In some embodiments, the appended performance metrics may be small so the additional load on the network due the transfer of performance metrics is minimal.

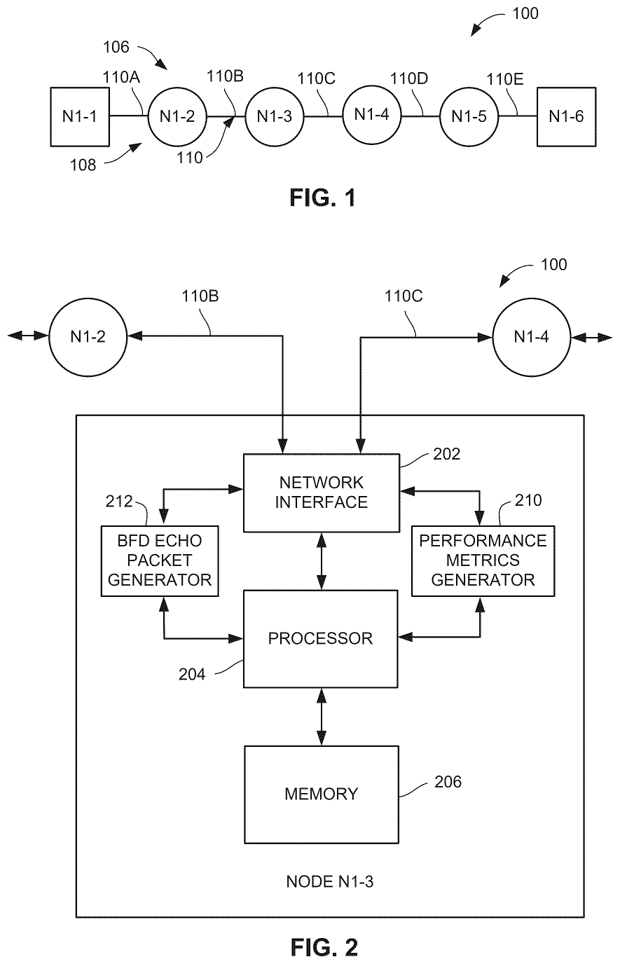

Reference is made to FIG. 1, which illustrates a diagram of a simple network 100. The network 100 may be considered a communications path of a larger network. The network 100 is a communication network configured to transfer data between a first node N1-1 and a sixth node N1-6. The first number in the node numbering refers to the embodiment and the second number refers to the node in that embodiment. Thus, the node N1-1 refers to the first node in the first embodiment. The first node N1-1 and the sixth node N1-6 may be any devices that receive, transmit, generate, and/or relay data. In some embodiments, the first node N1-1 and the sixth node N1-6 may be devices such as computers, smartphones, servers, cameras, and devices associated with the Internet of Things (IoT). The first node N1-1 and/or the sixth node N1-6 may be referred to as endpoint nodes of the network 100. For example, the first node N1-1 may be an upstream endpoint node and the sixth node N1-6 may be a downstream endpoint node.

In the embodiment of FIG. 1, the network 100 includes four intermediate nodes coupled between the first node N1-1 and the sixth node N1-6. The intermediate nodes are referenced individually as a second node N1-2, a third node N1-3, a fourth node N1-4, and a fifth node N1-5. Examples of the intermediate nodes include routers, bridges, switches, and other devices that transfer and/or route data. The nodes 106 transfer data between each other to facilitate data communications between the first node N1-1 and the sixth node N1-6. The nodes 106 in the network 100 are shown connected in series. Other network embodiments may include nodes connected in parallel or a combination of series and parallel.

A communications path 108 links the first node N1-1 and the sixth node N1-6 via the intermediate nodes. The communications path 108 may include a plurality of communications links 110 between the nodes 106. In the embodiment of FIG. 1, the communications path 108 includes a first communications link 110A between the first node N1-1 and the second node N1-2, a second communications link 110B between the second node N1-2 and the third node N1-3, a third communications link 110C between the third node N1-3 and the fourth node N1-4, a fourth communications link 110D between the fourth node N1-4 and the fifth node N1-5, and a fifth communications link 110E between the fifth node N1-5 and the sixth node N1-6. The communications links 110 may be combinations of wireless communication links (e.g., WIFI and satellite links) and wired links (e.g., ethernet cables).

Performance metrics of the nodes 106 and/or the communications links 110 provide information as to the communications quality between the first node N1-1 and the sixth node N1-6. Examples of performance metrics include latency, jitter, packet loss, queue depth, and other metrics that affect communications in the network 100. Performance metrics of the network 100 may be transmitted throughout the network 100 by being appended to return bidirectional forward detection (BFD) echo packets. In conventional networks, BFD echo packets are used to detect connectivity failures between two forwarding engines or nodes. BFD operates by transmitting outgoing BFD echo packets periodically to a node and checking whether the return BFD echo packets are received within a specified period.

When a node transmits an outgoing BFD echo packet, the node may be referred to as an originating node. The source and destination of the packet, which may be in the header of the packet, are the same, so the packet is returned to the sending or originating node. For example, with regard to the second communications link 110B between the second node N1-2 and the third node N1-3, the second node N1-2 may be an originating node and may transmit outgoing BFD echo packets with an internet protocol (IP) source of the second node N1-2, an IP destination of the second node N1-2, a media access control (MAC) source address of the second node N1-2, and a MAC destination address of the third node N1-3. When the BFD echo packets are received in the third node N1-3, the third node N1-3 echoes or returns the packets in its regular forwarding path wherein the IP source and destination do not change (second node N1-2), the MAC source address is the third node N1-3 and the MAC destination address is the second node N1-2. BFD echo packets are typically transmitted continuously and at a very high rate. For example, BFD echo packets may be transmitted continuously every 1 ms or 10 ms. BFD echo packets may be transmitted at higher or lower rates. The high rate of BFD echo packet transmissions with the appended performance metrics provides substantially real time network status to the nodes 106.

An example of performance metrics transmitted via return BFD echo packets is provided in a situation wherein the sixth node N1-6 may collect and/or generate performance metrics pertaining to the sixth node N1-6 and/or between two points in the network 100. The fifth node N1-5 may transmit outgoing BFD echo packets to the sixth node N1-6. Performance metrics stored in the sixth node N1-6 may be appended (e.g., encapsulated) to return BFD echo packets that are transmitted or returned to the fifth node N1-5. The fifth node N1-5 may extract (e.g., decapsulate) the performance metrics from the return BFD echo packets and analyze the network 100 at least partially based on the received performance metrics. Other embodiments herein describe transmitting the performance metrics of the sixth node N1-6 throughout the network 100.

As described above, the node receiving the return BFD echo packets may analyze the appended performance metrics to determine performance or characteristics of the network 100. For example, one or more of the nodes 106 may collect performance metrics, such as via in-band or integrated operations, administration, and maintenance (IOAM) protocols. IOAM protocols collect operational and telemetry information (e.g., performance metrics) in packets while the packets traverse a path between two points in the network 100. The performance metrics may be decapsulated from the packets and stored in the nodes 106. The performance metrics are then appended to return BFD echo packets, which are returned to the node that transmitted the respective outgoing BFD echo packet. The performance metrics may then be extracted from the return BFD echo packets. In some embodiments, the performance metrics may be accumulated and analyzed, which provides an analysis of the entire network 100. BFD echo packets may be continuously transmitted, so the status of the network 100 is able to be continuously updated and monitored. The BFD process may operate at a high rate such that the network status may be monitored in real time or substantially in real time. For example, each node may transmit outgoing BFD echo packets at a rate of one per millisecond.

Having described embodiments of using BFD echo packets to transmit performance metrics throughout the network 100, more detailed descriptions of the network 100, the nodes 106, and the use of the BFD echo packets will now be provided. Additional reference is made to FIG. 2, which illustrates a block diagram of an embodiment of the third node N1-3. The description of the third node N1-3 described with reference to FIG. 2 may be applicable to other nodes and devices in the network 100. It is noted that the first node N1-1 and the sixth node N1-6 may, in some embodiments, have different configurations and are described below. The nodes 106 are described as having individual components, such as network interfaces, BFD echo packet generators, processors, and memories. These individual components may be implemented on single circuits, such as single integrated circuits, as processors, or in firmware or software. Thus, some of the components described herein may be integrated together.

The third node N1-3 may include a network interface 202 that connects the third node N1-3 to the network 100. For example, the network interface 202 may connect the third node N1-3 to the second communications link 110B and the third communications link 110C, which enables the third node N1-3 to communicate via the communications path 108. Thus, the third node N1-3 may communicate directly with the second node N1-2 and the fourth node N1-4. The network interface 202 may capture packets transmitted on the communications path 108 that are intended to be processed by the third node N1-3. The network interface 202 may also transmit packets onto the communications path 108 with header information indicating the destinations of these packets. In that regard, the network interface 202 may transmit outgoing BFD echo packets and may receive return BFD echo packets. Additionally, the network interface 202 may return outgoing BFD echo packets transmitted from other nodes (e.g., the second node N1-2 and the fourth node N1-4) as described herein.

The third node N1-3 may include a processor 204 that is in communication with the network interface 202. In some embodiments, the network interface 202 may be integrated with the processor 204 or may be a processor. The processor 204 may perform actions required to operate the third node N1-3, which may include executing computer code to perform the actions. In other embodiments, the processor 204 may be programmed by software (e.g., computer code) to perform the actions, wherein the software may be received from outside the third node N1-3. For example, a network administrator or the like may transmit software on the network 100 that is received by the third node N1-3 and causes the third node N1-3 to perform at least some of the actions described herein. Software executed by the processor 204 may be stored in memory 206 that may be integrated into or in communication with the processor 204. The software may cause the processor 204 to analyze incoming packets and configure outgoing packets. With regard to the performance metrics, the software may cause the processor 204 to append performance metrics (e.g., IOAM data) to return BFD echo packets as described herein.

The processor 204 may also extract performance metrics (e.g., IOAM data) from return BFD echo packets. The extracted performance metrics may be processed by the processor 204 to generate performance characteristics of the network 100 or portions of the network 100. The processor 204 may also extract data that includes locations in the network 100 where the performance metrics were obtained. For example, the extracted data may pertain to performance metrics of the fourth communications link 110D and the fourth node N1-4. The extracted performance metrics and the locations where the performance metrics were obtained may be stored in the memory 206. The performance metrics may also be read from the memory 206 by the processor 204 and appended to return BFD echo packets as described herein.

The third node N1-3 may include a performance metrics generator 210 that may be configured to collect, analyze, and/or process performance metrics. Some of the performance metrics may be obtained or generated using IOAM processes. The performance metrics may pertain to performance of the third node N1-3, the second communications link 110B, and/or the third communications link 110C. As described herein, the performance metrics may also pertain to performance metrics associated with other nodes in the network 100 that have been transmitted to the third node N1-3. The performance metrics generator 210 may communicate with the processor 204 to store generated and/or collected performance metrics in the memory 206. In some embodiments, the performance metrics generator 210 may be implemented as software executed by the processor 204. In other embodiments, the performance metrics generator 210 may be implemented as firmware, hardware, or a processor.

In some embodiments, the performance metrics generator 210 may receive data packets containing performance metrics related to the third node N1-3 and/or other nodes, communication links, and/or devices within the network 100. The performance metrics generator 210 may extract (e.g., decapsulate) the performance metrics from these data packets using, for example, conventional IOAM processing techniques. The performance metrics may then be stored or processed as described herein. In some embodiments, the performance metrics generator 210 may also process or transform performance metrics to a format that enables the performance metrics to be appended to return BFD echo packets as described herein.

The third node N1-3 may also include a BFD echo packet generator 212. The BFD echo packet generator 212 may generate outgoing BFD echo packets for transmission to the second node N1-2 and/or the fourth node N1-4. In some embodiments, the BFD echo packet generator 212 may be implemented as software executed by the processor 204. In other embodiments, the BFD echo packet generator 212 may be implemented in the processor 204 or the network interface 202. Accordingly, the processor 204 may generate the outgoing BFD echo packets or cause the BFD echo packet generator 212 to generate outgoing BFD echo packets. In some embodiments, the BFD echo packet generator 212 may append the performance metrics to return BFD echo packets. For example, the processor 204 may instruct the BFD echo packet generator 212 to append certain performance metrics to the return BFD echo packets for processing by the second node N1-2 or the fourth node N1-4.

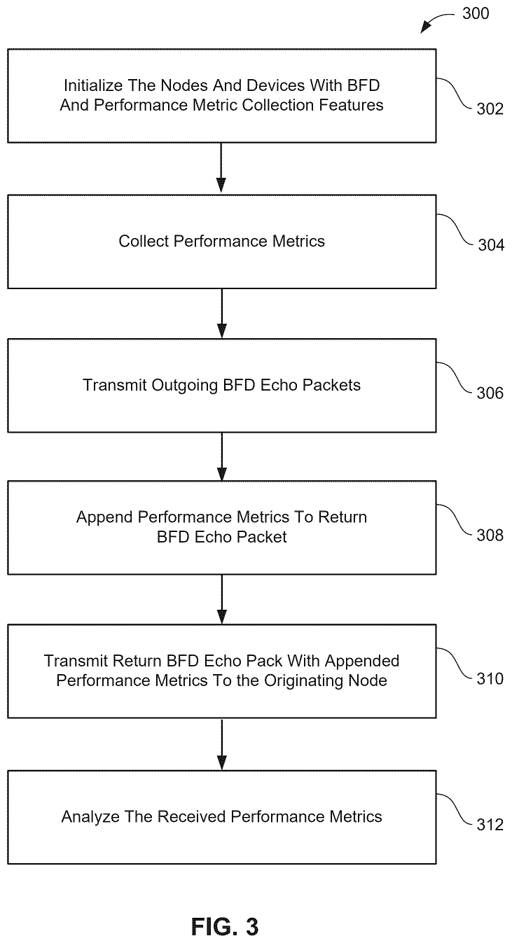

Having described the components of the third node N1-3, the operation of the third node N1-3 will now be described. The operation of the third node N1-3 may be identical or substantially similar to the operation of other nodes, such as other intermediate nodes, in the network 100. Additional reference is made to FIG. 3, which is a flowchart describing a method 300 of operating the third node N1-3. The method 300 may commence with initializing at least two nodes in the network 100 with the BFD echo and performance metric collection features per operational block 302. The performance collection feature enables the third node N1-3 to collect performance metrics using protocols such as IOAM. The initialization may be performed by a node or device of the network 100 transmitting instructions (e.g., software) to the processor 204 that cause the processor 204 to run or initialize the performance metrics generator 210 and the BFD echo packet generator 212. The BFD echo feature may configure the third node N1-3 to send BFD echo packets at 1 ms intervals, for example. The performance metric collection feature may be configured to collect performance metrics pertaining to communications path 108 and/or the nodes 106 in the network 100.

In operational block 304, one or more of the nodes 106 start collecting performance metrics. The performance metrics may be collected for all the nodes on the network 100 or, in some embodiments, for downstream nodes. In such embodiments, the third node N1-3 may collect performance metrics from the fourth node N1-4 and/or the third node N1-3. The third node N1-3 may also collect performance metrics for the third communications link 110C. The fourth node N1-4 may collect performance metrics for the fourth node N1-4 and the fourth communications link 110D. The fifth node N1-5 may collect performance metrics for the fifth node N1-5 and the fifth communications link 110E. Based on the foregoing, the performance metrics may pertain to communications between a first point or a first portion of the network 100 and a second point or a second portion of the network 100, such as between the third node N1-3 and the fifth node N1-5. The collected performance metrics may be stored in the memory 206 of each of the nodes 106.

In operational block 306, outgoing BFD echo packets are transmitted by one or more of the nodes 106. For example, outgoing BFD echo packets may be transmitted from the second node N1-2 to the third node N1-3. In addition, the third node N1-3 may transmit outgoing BFD echo packets to the fourth node N1-4.

In operational block 308, the performance metrics are appended to return BFD echo packets. This process may be referred to as encapsulating the performance metrics with the BFD echo packets. With regard to the third node N1-3, the third node N1-3 may receive an outgoing BFD echo packet transmitted from the second node N1-2. Prior to returning the return BFD echo packet back to the second node N1-2, the network interface 202 or other device in the third node N1-3 may append performance metrics collected by the performance metrics generator 210 or stored in the memory 206 to the return BFD echo packet. In some embodiments, the performance metrics may be in the form of IOAM data.

In operational block 310, the return BFD echo packets with the appended performance metrics are transmitted back to the originating node. When applied to the third node N1-3, the second node N1-2 has transmitted an outgoing BFD echo packet to the third node N1-3. The third node N1-3 then transmits or returns a return BFD echo packet with the appended performance metrics back to the second node N1-2. In a similar manner if the third node N1-3 transmitted an outgoing BFD echo packet to the fourth node N1-4, the fourth node N1-4 transmits a return BFD echo packet with appended performance metrics back to the third node N1-3.

In some embodiments, the processor 204 may append a first portion of the performance metrics to a first return BFD echo packet and a second portion of the performance metrics to a second return BFD echo packet in order to minimize packet sizes. If all the performance metrics were appended to a single return BFD echo packet, the packet may be large enough to hamper the operation of the network 100, especially as the network 100 grows. This issue may be illustrated by situations where the fifth node N1-5 sends performance metrics of the fifth communications link 110E, the sixth node N1-6, and/or the fifth node N1-5 to the fourth node N1-4 on a return BFD echo packet. The fourth node N1-4 may aggregate these performance metrics with performance metrics collected in the fourth node N1-4, such as performance metrics relate to the fourth node N1-4 and/or the fourth communications link 110D. The aggregated performance metrics may then be appended to a return BFD echo packet returning to the third node N1-3 where even more performance metrics are added to the aggregated performance metrics. Eventually, the aggregated data appended to a return BFD echo packet may increase latency in the network 100 and create other problems. In order to overcome these situations, the nodes may only append small portions of the performance metrics to individual return BFD echo packets. These small portions may, for example, pertain to performance metrics of a single node or a single communications link.

In operational block 312, the performance metrics are analyzed. For example, performance metrics received at the third node N1-3 may be analyzed to determine optimal communications paths between two points in the network 100 (i.e., the third node N1-3 and the fourth node N1-4). In some embodiments, the first node N1-1 may be an upstream endpoint node and may receive performance metrics for some or all the communications links 110 and nodes 106 in the network 100. The first node N1-1 may then determine optimal communications based on the analyzed performance metrics. More detailed examples of determining optimal communications is described relative to the network 700 in FIG. 7.

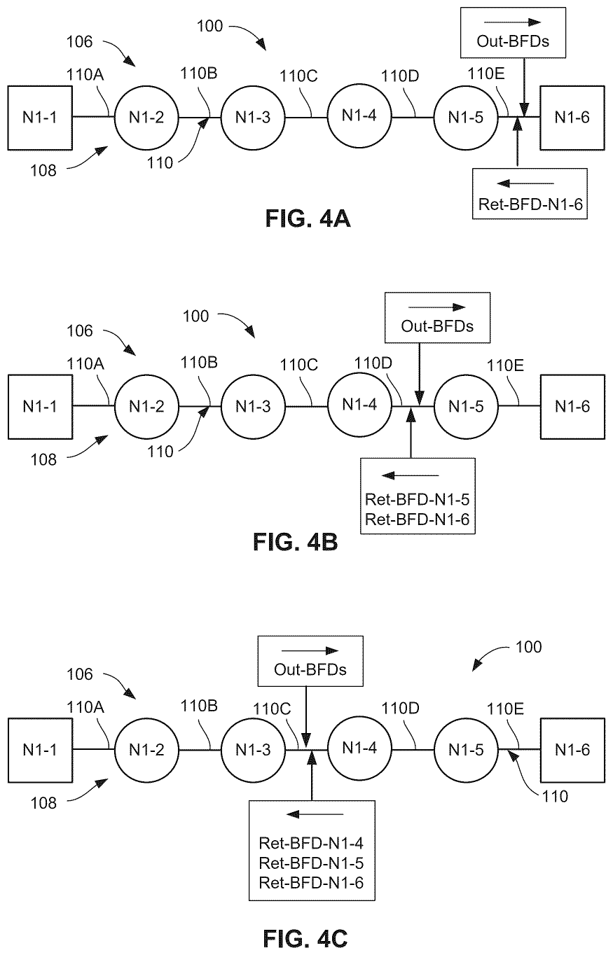

As briefly described above, the nodes 106 may be programmed to transmit or relay the performance metrics in a daisy chain or round robin format so that large return BFD echo packets that have performance metrics pertaining to several of the nodes 106 are not continually transmitted via the network 100. Additional reference is made to FIGS. 4A-4C, which illustrate an example of the round robin or daisy chain data transmission in the network 100. The following example may commence with the sixth node N1-6 collecting and/or generating performance metrics. As shown in FIG. 4A, the fifth node N1-5 may transmit outgoing BFD echo packets to the sixth node N1-6 on the fifth communications link 110E and the second node may transmit return BFD echo packets with performance metrics pertaining to the sixth node N1-6.

At this point, the fifth node N1-5 has performance metrics of the fifth node N1-5 and the sixth node N1-6. Referring to FIG. 4B, the fourth node N1-4 may transmit outgoing BFD echo packets to the fifth node N1-5 on the fourth communications link 110D. Performance metrics pertaining to the sixth node N1-6 may be appended to a first return BFD echo packet and transmitted to the fourth node N1-4. Performance metrics pertaining to the fifth node N1-5 may be appended to a second return BFD echo packet and transmitted to the fourth node N1-4. In addition to appending the performance metrics, the locations in the network 100, such as a node or the like, from where the performance metrics were obtained may also be appended to the return BFD echo packets.

The fourth node N1-4 now has performance metrics pertaining to the fourth node N1-4, the fifth node N1-5, and the sixth node N1-6 that are to be transmitted to the third node N1-3 via return BFD echo packets. Referring to FIG. 4C, the third node N1-3 transmits outgoing BFD echo packets to the fourth node N1-4 on the third communications link 110C. The transmission of the performance metrics to the third node N1-3 may be accomplished using three return BFD echo packets. A first return BDF echo packet may transmit performance metrics of the sixth node N1-6, a second return BFD echo packet may transmit performance metrics of the fifth node N1-5, and a third return BFD echo packet may transmit performance metrics of the fourth node N1-4. In some embodiments, a single BFD return packet may have performance metrics of two or more nodes. Thus, the status of the network 100 has been transmitted throughout the network 100 quickly and with minimal effects on the network 100.

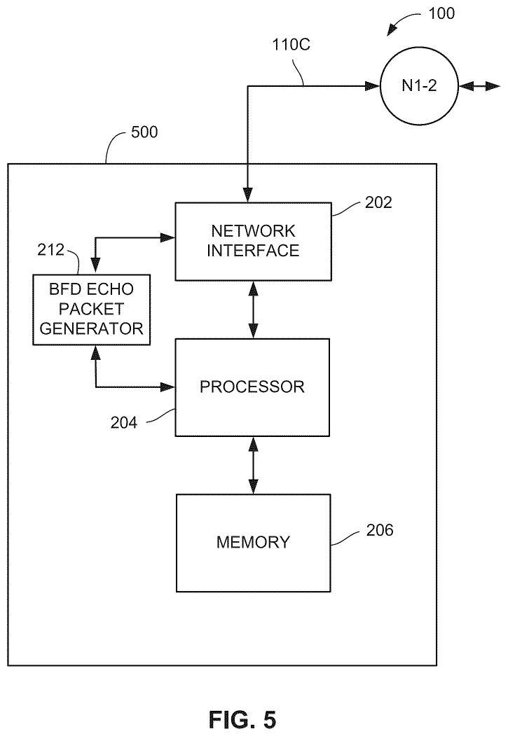

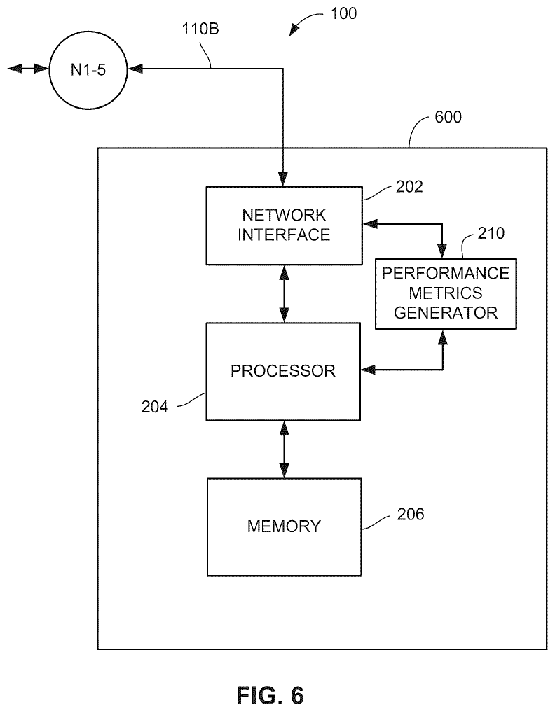

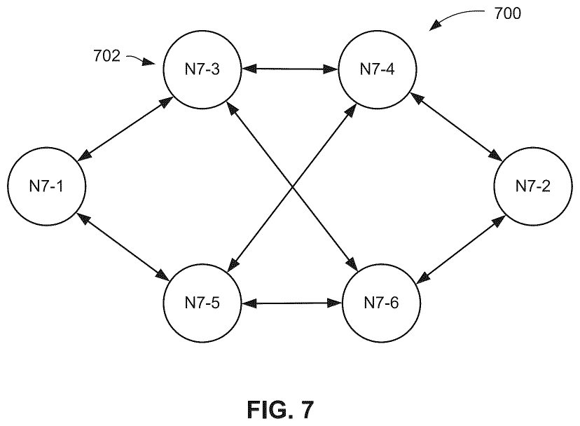

Reference is now made to FIGS. 5 and 6, which illustrate different embodiments of the nodes. Not all the nodes 106 in the network 100 may include all the components of the third node N1-3. Therefore, not all the nodes 106 in the network 100 may perform all the functions described relative to the third node N1-3. Reference is made to FIG. 5, which illustrates a block diagram of an embodiment of a node 500 that does not include a performance metrics generator. The node 500 may be an upstream end node, such as the first node N1-2 (FIG. 1) that may not generate performance metrics. However, the node 500 may receive performance metrics from other nodes in the network 100. For example, the node 500 may include the BFD echo packet generator 212 that transmits BFD echo packets to other nodes, such as to the second node N1-2 (FIG. 1). The node 500 then receives return BFD echo packets with appended performance metrics. The node 500 may process the performance metrics as described herein.

Reference is made to FIG. 6, which illustrates an embodiment of a node 600 that does not include a BFD echo packet generator. The node 600 may be similar to embodiments of the sixth node N1-6 that may not include a BFD echo packet generator. The node 600 may be a downstream end node that appends performance metrics to return BFD echo packets, but does not generate outgoing BFD echo packets. The node 600 may acquire performance metrics from IOAM routines or other methods, which may be appended to return BFD echo packets.

The methods of transmitting performance metrics throughout a network using the above-described nodes may be applied to more sophisticated networks than the network 100 of FIG. 1. Additional reference is made to FIG. 7, which illustrates a network 700 that includes a plurality of different communications paths between a plurality of nodes 702. In the embodiment of FIG. 7, a first node N7-1 may be an upstream endpoint node and a second node N7-2 may be a downstream endpoint node. The network 700 may have a plurality of different communication paths between the first node N7-1 and the second node N7-2.

The methods and nodes described herein enable the large number of nodes 702 to transmit performance metrics throughout the network 700 without overwhelming the network 700. For example, each return BFD echo packet may have one or a few performance metrics appended to them. For example, each return BFD echo packet may have performance metrics pertaining to one node or one communication link. Other embodiments may have performance metrics pertaining to two nodes appended to the return BFD echo packets so long as the larger return BFD echo packets do not overwhelm the network 700.

During operation of the network 700, the second node N7-2 may collect performance metrics as described herein. For example, the network 700 may use IOAM techniques and other techniques to collect the performance metrics. The fourth node N7-4 and the sixth node N7-6 may transmit outgoing BFD echo packets to the second node N7-2. The second node N7-2 may append performance metrics to return BFD echo packets returning to the fourth node N7-4 and the sixth node N7-6. The second node N7-2 may also append information to the return BFD echo packets indicating which node or portion of the network 700 the performance metrics pertain to.

The fourth node N7-4 may now have performance metrics pertaining to the second node N7-2, the fourth node N7-4, and/or communication links associated with the second node N7-2 and the fourth node N7-4. The sixth node N7-6 may have performance metrics pertaining to the second node N7-2, the sixth node N7-6, and/or communication links associated with the second node N7-2 and the sixth node N7-6.

Both the third node N7-3 and the fifth node N7-5 may transmit outgoing BFD echo packets to the fourth node N7-4 and the sixth node N7-6. The fourth node N7-4 may append performance metrics pertaining to the second node N7-2 to a first return BFD echo packet and performance metrics pertaining to the fourth node N7-4 to a second return BFD echo packet. The fourth node N7-4 may do the same with return BFD echo packets to the fifth node N7-5. The fourth node N7-4 may continually receive performance metrics from the second node N7-2 and may continuously transmit the performance metrics to the third node N7-3 and the fifth node N7-5 using a rotational or round robin format. The sixth node may continuously transmit performance metrics in the same manner to the third node N7-3 and the fifth node N7-5.

The third node N7-3 now has performance metrics pertaining to the second node N7-2, the fourth node N7-4, the sixth node N7-6 in addition to the third node N7-3 and associated communication links. The fifth node N7-5 now has performance metrics pertaining to the second node N7-2, the fourth node N7-4, the sixth node N7-6 in addition to the fifth node N7-5 and associated communication links. The third node N7-3 and the fifth node N7-5 may use round robin formats to transmit these performance metrics to the first node N7-1. The first node N7-1 may transmit outgoing BFD echo packets to the third node N7-3 and the fifth node N7-5. The third node N7-3 may append performance metrics to of the second node N7-2 to a first return BFD echo packet, performance metrics of the fourth node N7-4 to a second BFD echo packet, performance metrics of the sixth node N7-6 to a third return BFD echo packet, and performance metrics of the third node N7-3 to a fourth return BFD echo packet. The fifth node N7-5 may append performance metrics stored therein to return BFD echo packets in a similar manner. The first node N7-1 thus receives performance metrics of the network 700 as a whole after receiving eight return BFD echo packets from the third node N7-3 and the fifth node N7-5. If the first node N7-1 generates BFD echo packets at a rate of one per millisecond, then the first node N7-1 receives performance metrics of the network 700 as a whole every eight milliseconds, which may be considered real time.

The nodes 702, including the first node N7-1, may aggregate the performance metrics to determine optimal communications paths for transmitting data. When these methods are applied to transmitting data from the first node N7-1 to the second node N7-2, the network 700 or the first node N7-1 may determine that there are issues with a first communications path and may redirect data to a second communications path. For example, the first node N7-1 may determine that there are issues with the fourth node N7-4 and the fifth node N7-5. Based on analysis of the network 700, the first node N7-1 may determine that a communications path via the third node N7-3 and the sixth node N7-6 provides the optimal communications path. This analysis may be performed by other nodes to determine optimal communications paths within the network 700. In the example provided above, the first node N7-1 may analyze the network every eight milliseconds and, thus, may select optimal communications paths every eight milliseconds.

The disclosure has described transmitting certain performance metrics throughout networks using BFD echo packets. In some embodiments the networks may transmit other performance metrics related to the networks via the BFD echo packets. The additional performance metrics may include, but are not limited to node temperature and energy consumed by the nodes. The energy consumption may be in categories such as renewable energy and non-renewable energy consumed. In some embodiments, the queue depth information may be transmitted throughout the network on the same BFD echo packets as the performance metrics.

The additional performance metrics may be factors as to which paths are used for data transmission. For example, if a node is hot, the analyses for path selection may determine that the node may be on the verge of failure and may direct data traffic away from that node. Energy consumption may be a factor in costs associated with the networks, especially high traffic networks such as those used for AI and ML. Data may be directed to lower energy consumption networks. In other embodiments, energy costs may be a function of time, such as being more expensive during daytime hours. In such embodiments, decisions may be made to transmit data via low energy nodes during peak energy cost periods.

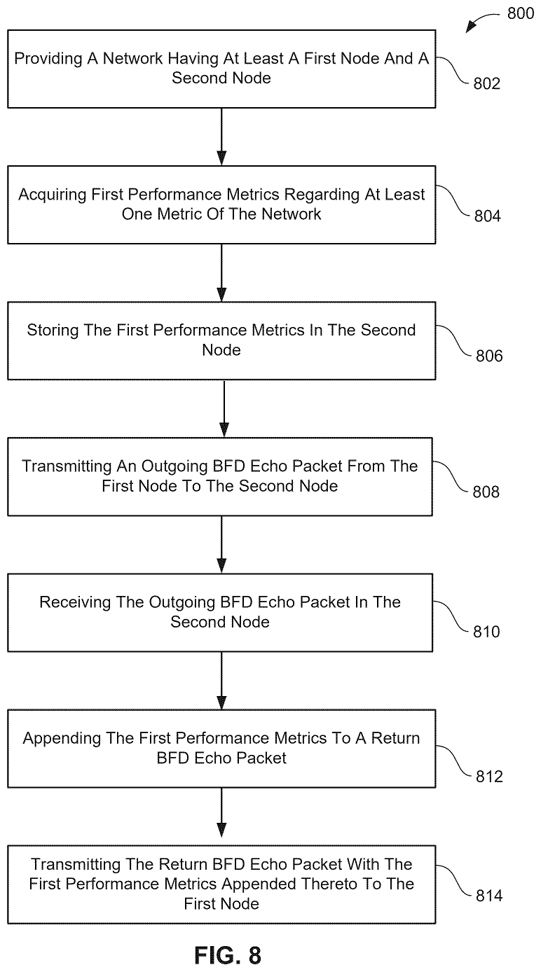

Reference is now made to FIG. 8, which illustrates a method 800 of operating a network (e.g., network 100 or network 700). The method 800 includes, at operational block 802, providing a network having at least a first node and a second node. Examples of the network include the network 100 and the network 700. Examples of the first node include the third node N1-3 (FIG. 1) and the fourth node N7-4 (FIG. 7). Examples of the second node include the fourth node N1-4 and the second node N7-2. The method 800 includes, at operational block 804, acquiring first performance metrics regarding at least one metric of the network. The method 800, includes at operational block 806, storing the first performance metrics in the second node. Examples of the storage include the memory 206 (FIG. 2). The method 800 includes, at operational block 808, transmitting an outgoing BFD echo packet from the first node to the second node. The method 800 includes, at operational block 810, receiving the outgoing BFD echo packet in the second node. The method 800 includes, at operational block 812, appending the first performance metrics to a return BFD echo packet. The method 800 includes, at operational block 814, transmitting the return BFD echo packet with the first performance metrics appended thereto to the first node.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the principles and novel features disclosed herein.

What is claimed is:

1. A node of a network, the node comprising:
a network interface configured to receive outgoing bidirectional forward detection (BFD) echo packets transmitted from an originating node and to transmit return BFD echo packets with performance metrics appended thereto back to the originating node;
a performance metrics generator configured to collect the performance metrics related to at least the node; and
a processor configured to append the performance metrics to the outgoing BFD echo packets.

2. The node of claim 1, wherein the performance metrics comprise at least one of latency between at least two points in the network and packet loss between at least two points in the network.

3. The node of claim 1, wherein the performance metrics comprise first performance metrics of a first portion of the network and second performance metrics of a second portion of the network, wherein the network interface is configured to transmit a first return BFD echo packet with the first performance metrics appended thereto and a second return BFD echo packets with the second performance metrics appended thereto to the originating node.

4. The node of claim 3, wherein the first portion of the network is between the node and a second node and wherein the second portion of the network is between the second node and a third node.

5. The node of claim 3, wherein the first portion of the network is between the node and a second node and wherein the second portion of the network is between the node and a third node.

6. The node of claim 1, further comprising a BFD echo generator coupled to the network interface and configured to:
generate outgoing BFD echo packets, and
receive return BFD echo packets having performance metrics appended thereto.

7. The node of claim 1, wherein the processor is further configured to select a communications path for transmitting data based at least in part on the performance metrics.

8. The node of claim 1, wherein the processor is further configured to aggregate performance metrics extracted from a plurality of return BFD echo packets.

9. The node of claim 1, wherein the performance metrics generator is an integrated operations, administration, and maintenance (IOAM) generator.

10. A node of a network, the node comprising:
a network interface configured to receive return bidirectional forward detection (BFD) echo packets with performance metrics appended thereto from at least a first node of the network; and
a processor coupled to the network interface, wherein the processor is configured to extract the performance metrics from the return BFD echo packets.

11. The node of claim 10, wherein the processor is further configured to aggregate performance metrics extracted from a plurality of return BFD echo packets.

12. The node of claim 10, wherein the performance metrics comprise at least one of latency between at least two points in the network and packet loss between at least two points in the network.

13. The node of claim 10, wherein the processor is further configured to select a communications path based at least in part on the performance metrics.

14. The node of claim 10, further comprising:
a performance metrics generator configured to collect performance metrics; and
a BFD echo packet generator configured to generate outgoing BFD echo packets,
wherein at least one of the BFD echo packet generator or the processor is configured to append the performance metrics to return BFD echo packets and wherein the network interface is configured to transmit the return BFD echo packets with the appended performance metrics to at least one node.

15. The node of claim 10, wherein the network interface is configured to receive a first return BFD echo packet with first performance metrics appended thereto and a second return BFD echo packet with second performance metrics appended thereto, and wherein the first performance metrics pertain to a first portion of the network and the second performance metrics pertain to a second portion of the network.

16. The node of claim 15, wherein the first portion of the network is between the node and a third node and wherein the second portion of the network is between the third node and a fourth node.

17. The node of claim 15, wherein the first portion of the network is between the node and a third node and wherein the second portion of the network is between the node and a fourth node.

18. A method of operating a network, the method comprising:
providing a network having at least a first node and a second node;
acquiring first performance metrics pertaining to at least one metric of the network;
storing the first performance metrics in the second node;
transmitting an outgoing BFD echo packet from the first node to the second node;
receiving the outgoing BFD echo packet in the second node;
appending the first performance metrics to a return BFD echo packet; and
transmitting the return BFD echo packet with the first performance metrics appended thereto to the first node.

19. The method of claim 18, further comprising:
acquiring second performance metrics of at least one metric of the network;
storing the second performance metrics in a third node of the network;
transmitting an outgoing BFD echo packet from the second node to the third node;
receiving the outgoing BFD echo packet in the third node;
appending the second performance metrics to a return BFD echo packet; and
transmitting the return BFD echo packet with the second performance metrics appended thereto from the third node to the second node.

20. The method of claim 19, further comprising:
receiving a first outgoing BFD echo packet in the second node transmitted from the first node;
appending the first performance metrics to a first return BFD echo packet;
transmitting the first return BFD echo packet with the first performance metrics appended thereto from the second node to the first node;
receiving a second outgoing BFD echo packet in the second node transmitted from the first node;
appending the second performance metrics to a second return BFD echo packet; and
transmitting the second return BFD echo packet with the second performance metrics appended thereto from the second node to the first node.

21. The method of claim 18, further comprising transmitting data between two points in the network based at least partially on performance metrics appended to the return BFD echo packet.

22. A network for transmitting data, the network comprising:
a first node; and
a second node,
wherein:
the first node is configured to: transmit outgoing BFD echo packets to the second node; receive return BFD echo packets from the second node; and extract first performance metrics from the return BFD echo packets, and
the second node is configured to: receive the outgoing BFD echo packets from the first node; append the first performance metrics to the return BFD echo packets; transmit the return BFD echo packets back to the first node.

23. The network of claim 22, further comprising a third node configured to:
collect second performance metrics;
receive outgoing BFD echo packets transmitted from the second node;
append the second performance metrics to return BFD echo packets; and
transmit the return BFD echo packets back to the second node, wherein the second node is further configured to:
receive return BFD echo packets from the third node;
extract the second performance metrics from the return BFD echo packets from the third node;
transmit first return BFD echo packets with the first performance metrics appended thereto the first node; and
transmit second return BFD echo packets with the second performance metrics appended thereto to the first node.

24. The network of claim 22, wherein the first performance metrics comprise at least one of latency between at least two points in the network and packet loss between at least two points in the network.
